(19) United States
(12) Patent Application Publication
(10) Pub. No.: US 2024/0269715 A1
(43) Pub. Date: Aug. 15, 2024

(54) SMOKING APPARATUS CLEANER

(71) Applicant: Greenmarket Enterprises, Inc., Plymouth, MI (US)

(72) Inventor: Peter Lafferty, East Hampton, NY (US)

(73) Assignee: Greenmarket Enterprises, Inc., Plymouth, MI (US)

(21) Appl. No.: 18/643,096

(22) Filed: Apr. 23, 2024

Related U.S. Application Data
(63) Continuation of application No. 18/487,632, filed on Oct. 16, 2023.
(60) Provisional application No. 63/477,005, filed on Dec. 23, 2022.
(60) Provisional application No. 63/508,415, filed on Jun. 15, 2023.

(51) Int. Cl. B08B 3/04; A24F 9/04

(52) U.S. Cl. CPC B08B 3/044; A24F 9/04

(57) ABSTRACT

Structures for cleaning a smoking apparatus include a first tube, defining a chamber, a first strainer, and a cleaning solution, filling with the cleaning solution. Structures may include a first cap removably attachable to the first tube or a neck formed on the first tube, such that the first cap attaches to the neck. The first tube may be filled with the cleaning solution, such that the smoking apparatus is placed into the first tube and agitated. The structure may include a second strainer, which is larger than the first strainer, and a second tube, which is larger than the first tube, may receive the second strainer. Methods may include filling a first tube, which defines a chamber, with a cleaning solution, placing the smoking apparatus into the cleaning solution, and agitating the cleaning solution and the smoking apparatus.

### CROSS-REFERENCE TO RELATED APPLICATION

This application claims priority to, and the benefit of, U.S. Nonprovisional application Ser. No. 18/487,632, filed Oct. 6, 2023, which claims priority to and the benefit of U.S. Provisional Application No. 63/477,005, filed Dec. 23, 2022, and U.S. Provisional Application No. 63/508,415, filed Jun. 15, 2023, all of which are hereby incorporated by reference in their entireties.

### INTRODUCTION

This disclosure generally relates to apparatuses for cleaning devices used for smoking.

### SUMMARY

A structure for cleaning a smoking apparatus and a method of cleaning a smoking apparatus are provided. This includes a first tube, defining a chamber, a first strainer, and a cleaning solution. The chamber may be filled with the cleaning solution.

The structure may include a first cap removably attachable to the first tube or a neck formed on the first tube, such that the first cap attaches to the neck. The first tube may be filled with the cleaning solution, such that the smoking apparatus is placed into the first tube and agitated within the cleaning solution. The structure may include a second strainer, which is larger than the first strainer, and a second tube, which is larger than the first tube, may receive the second strainer.

The methods may include filling a first tube, defining a chamber, with a cleaning solution and placing the smoking apparatus into the cleaning solution, then agitating the cleaning solution and the smoking apparatus. The time period for which the smoking apparatus may be agitated, may be around, or above, 25 seconds.

The above features and advantages, and other features and advantages, of the present disclosure are readily apparent from the following detailed description of some of the best modes and other embodiments for carrying out the disclosure, which is defined solely by the appended claims, when taken in connection with the accompanying drawings. questionnaire

### BRIEF DESCRIPTION OF THE DRAWINGS

FIG. 1A and FIG. 1B schematically illustrate views of an improved smoking apparatus cleaner: FIG. 1A shows an isometric view of the entire assembly with the lid raised; and FIG. 1B shows an isometric exploded view.

FIG. 2A and FIG. 2B schematically illustrate cross sectional views of an improved smoking apparatus cleaner: FIG. 2A shows a cross section with the lid raised; and FIG. 2B shows a cross section without the lid.

FIG. 3A and FIG. 3B schematically illustrate two exemplary sizes of strainer elements.

### DETAILED DESCRIPTION

Referring to the drawings, like reference numbers correspond to like or similar components wherever possible throughout the several figures. All figures may be referred to in any section of the specification, without regard to numerical order.

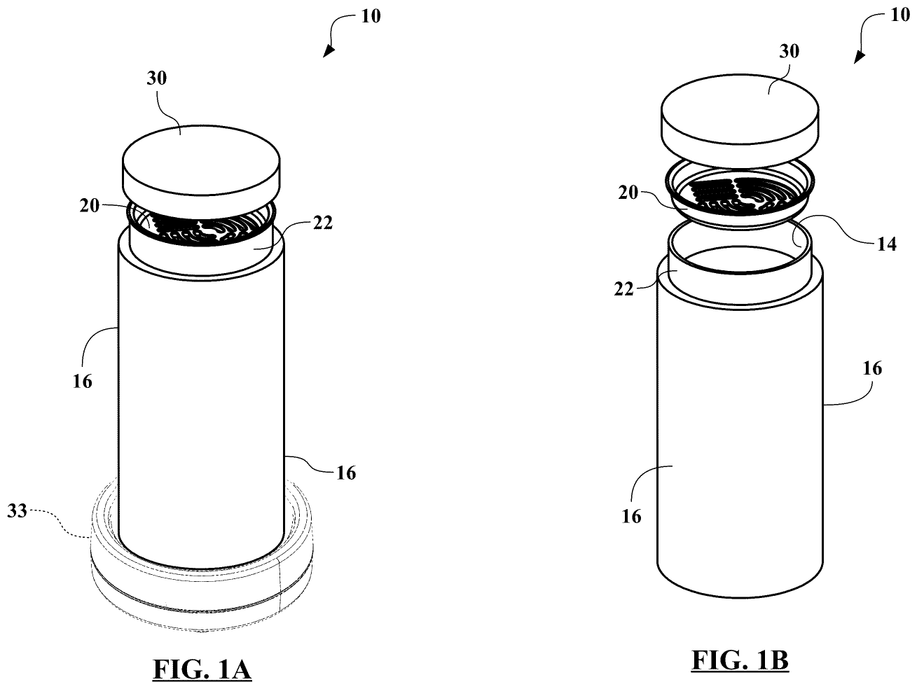

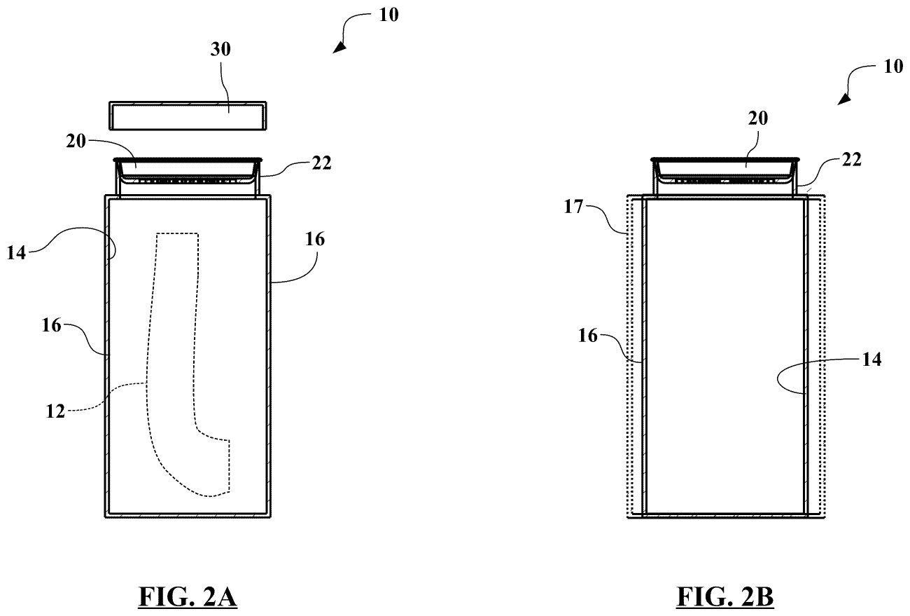

FIG. 1A and FIG. 1B show a smoking apparatus cleaner 10, or simply cleaner 10. This cleaner 10 may use shaking to assist in cleaning a smoking apparatus 12, shown schematically in FIG. 2A, which is placed inside of the cleaner 10. Note that other mechanisms may be used to clean the smoking apparatus 12, including, without limitation, oscillation or resting the smoking apparatus 12 within the cleaner 10 for a period of time.

The cleaner 10, in one or more embodiments, is generally cylindrical and holds a solvent or cleaning solution, which is not shown in the figures. The solvent or cleaning solution may be, for example, and without limitation, an all-natural, kosher, environmental, cleaning solvent to clean smoking apparatuses 12. The cleaning solution, for the smoking apparatus 12, may be referred to as RESINCLEANSE or RESIN CLEANSE. The smoking apparatus 12, or smoking apparatuses 12, may be of any kind, including, without limitation, tobacco, cannabis, vape devices, or other devices recognizable to those having ordinary skill in the art. Additionally, the smoking apparatus 12 may be formed from, without limitation, metal, glass, or other materials recognizable to skilled artisans. One of the reasons, without limitation, that the smoking apparatus 12 may need to be cleaned may be a buildup of resin caused by use of the smoking apparatus 12.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%. When used herein, the term “approximately” often refers to relationships where skilled artisans would recognize the amount of coverage needed.

The cleaner 10 in one or more embodiments includes a chamber 14, which is defined by, at least, a first tube 16. Note the first tube 16 may not have a circular perimeter, as generally shown in the figures, but may be, without limitation, triangular, rectangular, or other shapes recognizable to skilled artisans. Additional tubes may define the chamber 14, including telescoping tubes with the possibility of locking mechanisms joining the tubes.

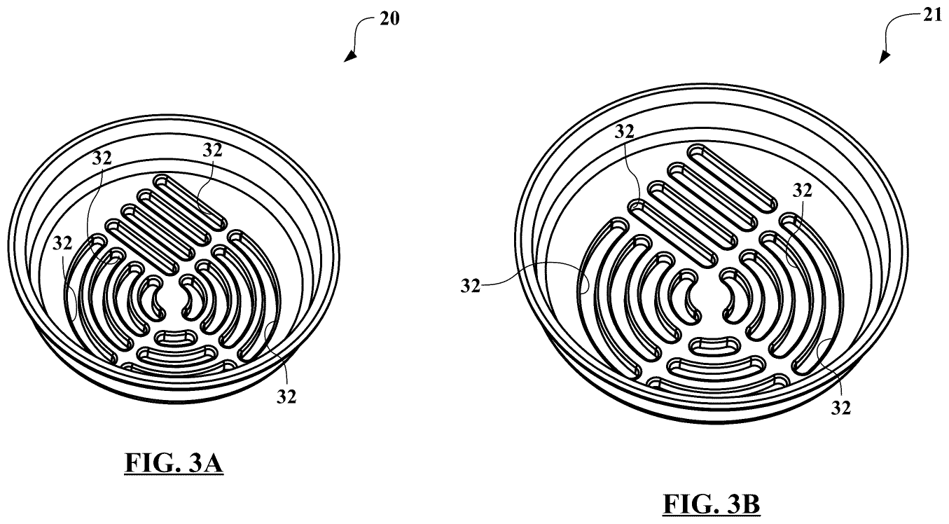

A strainer 20, which may be of varying size, as shown in FIG. 3A and FIG. 3B is attached to the first tube 16. A neck 22 extends upward from the first tube 16. Note, however, that the first tube 16 may not include the neck 22 and the strainer 20 may simply seat within the first tube 16.

In general, the consumer may simply shake the cleaner 10 for about, without limitation, 30 seconds, to activate the cleaning solution or solvent. Skilled artisans will recognize proper times for shaking, or letting the cleaner 10 sit, relative to achieving a cleaned smoking apparatus 12. Note that skilled artisans will recognize different amounts of time that that the smoking apparatus 12 may be cleaned or rested. This may be referred to as a period of time for cleaning the smoking apparatus 12 during which cleaning occurs. Note that, in some cases, the cleaner 10 may be placed on an oscillating base 33, such that the shaking is provided by the oscillating base 33, which is shown highly schematically in FIG. 1A.

A first cap 30 or top cap may be opened to add the solvent or cleaning solution to the chamber 14. The first cap 30 may clip or snap onto the first tube 16 or the neck 22. Note that some versions or configurations of the cleaner 10 may only have the first cap 30. FIG. 1A shows the cleaner 10 with the first cap 30 floating above and FIG. 1B shows an exploded view of the cleaner 10, such that you can view the strainer 20 inserted into the neck 22.

In situations where the first tube 16 is not cylindrical, the neck 22 may be needed to provide a screw, or threaded area, for the first cap 30. However, the first cap 30 may also simply snap or push onto the neck 22, or first tube 16, such that no screw or thread mechanism is needed.

A second cap or bottom cap, not shown, may or may not be smaller than the first cap 30, may be opened after shaking the cleaner 10 to drain the cleaning solvent. Note that the second cap may allow the user or consumer to rinse the cleaned smoking apparatus 12. For example, and without limitation, the user may rinse the cleaned smoking apparatus 12 under warm water in a sink, such that the water, resin, and cleaning solution is substantially flushed from the chamber 14. The second cap may be smaller, such that the opening on, generally, the bottom concentrates the exit of the cleaning fluid after each use and allows water to be flushed out under the faucet or similar device.

The materials of the cleaner 10 may be formed from any suitable material, including, without limitation, multiple types of plastic, as would be recognized by those having ordinary skill in the art. Placing the strainer 20 on top of the cleaner 10 allows the chamber 14 to easily receive the RESIN CLEANSE solution from a purchased pouch, which may be, without limitation, 16 or 24 ounces.

The chamber 14 may be configured to hold, without limitation, 16 ounces or more of the cleaning solution. Depending on the needs of the user of the cleaner 10, the chamber 14 may be substantially, or only partially, filled with the cleaning solvent. Skilled artisans will recognize the amount of cleaning solvent necessary, based on the type of smoking apparatus 12 and the number of smoking apparatuses 12 within the chamber 14.

FIG. 3A and FIG. 3B schematically illustrate two exemplary sizes of strainer elements. The strainer 20 may be a first strainer 20 and there is also shown a second strainer 21. Note that there are several slots 32 shown in the figures, the size, shape, and distribution of which are shown in a non-limiting exemplary implementation. Additional sizes and/or shapes of the slots 32 may be used, as will be recognized by those having ordinary skill in the art.

This allows the first strainer 20 or the second strainer 21 to be inserted in the first tube 16 and then have the cleaning solution poured through the first strainer 20 or the second strainer 21 to clean the smoking apparatus 12 within the chamber 14. Note that the second strainer 21 may be inserted into a second tube 17—shown highly schematically in FIG. 2B—but sized for the larger second strainer 21. Skilled artisans will recognize possible dimensions for the second tube. Note that the first tube 16 may be smaller than the second tube 17, and the second strainer 21 fits into the second tube 17.

The sizes of the strainers listed herein are exemplary and non-limiting, as will be recognized by those having ordinary skill in the art. The first strainer 20 may be, without limitation, between about 1.75-2.25 inches and may be for about an 8 fluid ounce container. The second strainer 21 may be, without limitation, between about 2.25-2.75 inches and may be for about 12-16 fluid ounce containers. In general, the height of either the first strainer 20 or the second strainer 21 may be between about 0.25-0.65 inches. In general, the first strainer 20 is smaller than the second strainer 21, as shown in FIG. 3A and FIG. 3B.

The detailed description and the drawings or figures are supportive and descriptive of the disclosure. Note that the drawings may not be to scale. While some of the best modes and other embodiments for carrying out the disclosure have been described in detail, various alternative designs, configurations, and embodiments exist for practicing the appended claims, as will be recognized by those having ordinary skill in the art.

1. A structure for cleaning a smoking apparatus, comprising:
a chamber, wherein the chamber is configured to receive therein a cleaning solution for cleaning the smoking apparatus; and
a first strainer configured to attach to a first tube.

2. The structure for cleaning a smoking apparatus of claim 1, further comprising:
a first cap removably attachable to the first tube.

3. The structure for cleaning a smoking apparatus of claim 2, further comprising:
a neck formed on the first tube, wherein the first cap attaches to the neck.

4. The structure for cleaning a smoking apparatus of claim 3, further comprising:
wherein the first tube is filled with the cleaning solution, and
wherein the smoking apparatus is placed into the first tube and agitated within the cleaning solution.

5. The structure for cleaning a smoking apparatus of claim 1, further comprising:
a second strainer, wherein the first strainer is smaller than the second strainer.

6. The structure for cleaning a smoking apparatus of claim 5, further comprising:
a second tube, wherein the first tube is smaller than the second tube, and the second strainer fits the second tube.

7. The structure for cleaning a smoking apparatus of claim 6, further comprising:
wherein the second tube is filled with the cleaning solution, and
wherein the smoking apparatus is placed into the second tube and agitated within the cleaning solution.

8. The structure for cleaning a smoking apparatus of claim 7, further comprising:
a neck formed on the first tube, wherein a first cap attaches to the neck.

9. A method of cleaning a smoking apparatus, the method comprising:
filling a first tube, defining a chamber, with a cleaning solution;
placing the smoking apparatus into the cleaning solution; and
agitating the cleaning solution and the smoking apparatus for a period of time.

10. The method of cleaning a smoking apparatus of claim 9, wherein agitating the cleaning solution and the smoking apparatus occurs via shaking.

11. The method of cleaning a smoking apparatus of claim 9, wherein agitating the cleaning solution and the smoking apparatus occurs via an oscillating base.

12. The method of cleaning a smoking apparatus of claim 9, wherein the period of time is at least 25 seconds.

13. The method of cleaning a smoking apparatus of claim 12, wherein agitating the cleaning solution and the smoking apparatus occurs via shaking.
